(19) United States
(12) Patent Application Publication
(10) Pub. No.: US 2012/0181232 A1
(43) Pub. Date: Jul. 19, 2012

(54) Method of Preparation of Samples for Analysis and Cartridge Therefore

(75) Inventor: Gong Chen, Leicester (GB)

(73) Assignee: FRITO-LAY TRADING COMPANY GMBH, Bern (CH)

(21) Appl. No.: 13/388,814

(22) PCT Filed: Aug. 4, 2010
(86) PCT No.: PCT/EP2010/061361

§ 371 Date: Feb. 3, 2012

(30) Foreign Application Priority Data
Aug. 4, 2009 (GB) 0913597.1

(51) Int. Cl. G01N 1/40; B01D 15/36; B01D 15/10

(52) U.S. Cl. 210/686; 210/282

(57) ABSTRACT

A method of preparing an aqueous sample for use in an analytical process, the sample comprising at least one water-soluble analyte derived from a foodstuff, the method comprising the steps of: (a) providing a solid-phase extraction cartridge comprising first and second sorbent materials arranged to absorb thereon different respective chemical components, the cartridge comprising a chamber containing the first and second sorbent materials and having an inlet and an outlet; (b) flowing through the inlet an aqueous sample comprising at least one water-soluble analyte derived from a foodstuff and impurities, thereby to dispose the sample within at least one of the first and second sorbent materials; (c) flowing through the inlet a washing liquid so as at least partially to separate the at least one water-soluble analyte and the impurities within the first and second sorbent materials; and (d) eluting the at least one water-soluble analyte from the outlet of the cartridge by flowing an elution liquid into the inlet.

### CROSS-REFERENCE TO RELATED APPLICATIONS

This application is a 371 National Stage Application claiming priority to PCT Application No. PCT/EP2010/061361 filed Aug. 4, 2010, which claims priority to Great Britain Application No. 0913597.1 filed Aug. 4, 2009, the technical disclosures of which are hereby incorporated by reference.

### BACKGROUND OF THE INVENTION

1. Technical Field

The present invention relates to a method of preparing samples for use in an analytical process and to a cartridge for use in such a preparation method. In particular, the present invention relates to the preparation of samples containing water-soluble analytes extracted from foodstuffs, for example acrylamide.

It is known to extract compounds from foodstuffs for analysis. For example, it is known to use solid-phase extraction (SPE) to remove impurities from an extract from a foodstuff and to subject the purified sample to analysis by a liquid chromatography/tandem mass spectrometry (LC/MS/MS) technique. SPE uses the affinity of solutes, dissolved or suspended in a liquid (known as the mobile phase), for a solid through which the sample is passed (the solid is known as the stationary phase and comprises a sorbent material) to separate a mixture into desired and undesired components. The stationary phase is provided in the form of a syringe-shaped cartridge packed with the sorbent material. The sorbent material can be selected to retain thereon, by absorption, either the desired analyte or undesired impurities. Some analyte-specific and solvent-specific SPE systems have been developed, which use particular SPE sorbents. For example, it is known to use an SPE cartridge using a multi-layer sorbent (known as the Supelclean ENVI-Carb-II/PSE SPE tube available from Sigma-Aldrich Co. of Bellefonte, Pa., USA) for extraction of pesticides from agricultural products using an organic solvent such as acetonitrile.

2. Description of Related Art

In recent years some health and safety concerns have been raised about the presence of the chemical acrylamide in certain foods, which is believed to form as a by-product of certain cooking processes. The United States Food and Drug Administration (FDA) has developed an analytical method for the quantitative determination of acrylamide in foods (“Detection and Quantification of Acrylamide in Foods” published as a Draft on 20 Jun. 2002, updated 23 Jul. 2002 and 24 Feb. 2003, by U.S. Department of Health and Human Services, U.S. Food and Drug Administration, Center for Food Safety and Applied Nutrition, Office of Plant & Dairy Foods & Beverages).

That method developed by the FDA uses a particular solid-phase extraction (SPE) methodology, together with associated apparatus, to remove impurities from an acrylamide-containing extract from a foodstuff in a cleanup process, in order to prepare the sample for subsequent analysis by liquid chromatography/tandem mass spectrometry (LC/MS/MS).

In particular, the FDA acrylamide LC/MS/MS sample cleanup process using two sequential and separate cleanup procedures each employing a respective SPE cartridge, each cartridge containing a respective stationary phase. A first SPE cartridge for use in the first SPE step uses a polymeric sorbent, available in commerce as Oasis HLB from Waters Corporation, Milford, Mass., USA, as the stationary phase and a second SPE cartridge for use in the second SPE step uses a mixed mode sorbent which exhibits strong cation exchange and strong anion exchange and incorporates C₈ active groups, available in commerce as Bond Elut Accucat from Varian, Inc., Harbor City, Calif., USA, as the stationary phase.

In greater detail, the FDA cleanup process requires a first cleanup procedure using the first cartridge as follows: condition OASIS SPE cartridge with 3.5 ml methanol, followed by 3.5 ml of water. Discard methanol and water portions used to prepare cartridge. Load OASIS SPE cartridge with 1.5 ml of the test portion extract. Allow extract to pass completely through the sorbent material. Elute column with 0.5 ml water and discard. Elute column with additional 1.5 ml water and collect for subsequent SPE cartridge cleanup.

A second subsequent cleanup procedure using the second cartridge is as follows: Place mark on outside of Varian SPE cartridge at height of 1 ml liquid above sorbent bed. Condition Varian SPE cartridge with 2.5 ml methanol, followed by 2.5 ml of water. Discard methanol and water portions used to prepare cartridge. Load 1.5 ml portion collected from first cleanup procedure and elute to 1 ml mark before collecting remainder of eluted portion. Transfer to 2 ml amber auto-sampler vial for LC/MS/MS analysis.

The FDA testing protocol indicates that a high degree of testing accuracy can be achieved, for example to sub-50 ppb measurements. However, such accuracy is achieved at the expense of a testing protocol which is very time consuming and inflexible. For example, it is stated that the revised analytical method allows one person to prepare 12 portions for analysis in about 1.5 hours. The manual multi-step process is very time consuming and labour intensive. Also, the FDA found that for the first cleanup procedure a number of SPE cartridges were tested during development of the method, and all of them had different analyte retention and elution characteristics. Accordingly the protocol prescribes not to substitute another SPE sorbent in this step without testing. Yet further the protocol prescribes to not use a vacuum to speed up the elution process in any of the SPE steps. In other words, in the SPE steps the mobile liquid phase is required to pass through the stationary solid phase drop-wise, under the action of gravity.

Although it is known from literature that two cartridges can be stacked vertically, connected by an adapter, however the present inventors found that such a stack was mechanically unstable, suffered high back-pressure preventing liquid flow therethrough, and was unsuitable for automated SPE cleanup. Therefore even though automated SPE cleanup as a technique is known per se, there was still a problem as to how to automate the acrylamide cleanup while still operating within the ambit of the protocol itself.

Another problem with the protocol found by the present inventors was that the multi-step manual method could give rise to variations in the amount of acrylamide detected, apparently due to variations in the degree of separation of the desired analyte, acrylamide, from the undesired impurities within the solid phase. This problem was believed to result from sensitivity to variations in the degree of packing of the sorbent material within the cartridge.

In summary therefore, the known acrylamide cleanup procedure is time-consuming, labour intensive and very prone to error. The flow rate of the sample and liquid passing through the cartridges varies considerably, depending on the nature of the sample extracts. This variation can potentially affect the later analysis.

The present invention aims at least partially to overcome these problems of the known SPE cleanup method for acrylamide-containing samples and, more broadly, to provide a method, and a cartridge for use in the method, for the preparation of samples containing water-soluble analytes extracted from foodstuffs, of which acrylamide is merely one example.

### SUMMARY OF THE INVENTION

Accordingly, the present invention provides a method of preparing an aqueous sample for use in an analytical process, the sample including at least one water-soluble analyte derived from a foodstuff, the method comprising the steps of:

(a) providing a solid-phase extraction cartridge comprising first and second sorbent materials arranged to absorb thereon different respective chemical components, the cartridge comprising a chamber containing the first and second sorbent materials and having an inlet and an outlet;
(b) flowing through the inlet an aqueous sample comprising at least one water-soluble analyte derived from a foodstuff and impurities, thereby to disperse the sample within at least one of the first and second sorbent materials;
(c) flowing through the inlet a washing liquid so as at least partially to separate the at least one water-soluble analyte and the impurities within the first and second sorbent materials; and
(d) eluting the at least one water-soluble analyte from the outlet of the cartridge by flowing an elution liquid into the inlet.

The method may further comprise the step, between steps (a) and (b) of conditioning the sorbent materials by flowing at least one conditioning liquid through the inlet into the cartridge.

Preferably, the first and second sorbent materials are arranged as a stack of two layers within the cartridge.

Typically, the first sorbent material is disposed as an upper layer on an inlet side of the cartridge and comprises a polymeric sorbent material which is adapted to absorb thereon hydrophobic organic molecules and/or the second sorbent material is disposed as a lower layer on an outlet side of the cartridge and comprises a mixed-mode silica-based sorbent material which is adapted to absorb thereon anionic and cationic components.

Typically, equal amounts of the first and second sorbent materials are present in the cartridge.

Preferably, in each of steps (b), (c) and (d) the respective liquid is injected into the cartridge at a positive fluid pressure and at a controlled flow rate.

More preferably, the controlled flow rate is preset.

Desirably, equal controlled flow rates are employed in each of steps (b), (c) and (d).

Optionally, equal amounts of liquid are injected through the inlet in each of steps (b), (c) and (d).

In a most preferred embodiment, the at least one water-soluble analyte comprises acrylamide.

The method may further comprise the step of disposing the cartridge in an apparatus having a liquid injection device adapted to communicate with the inlet, a source of the washing liquid and a source of the elution liquid, the sample being mounted with respect to the apparatus and the liquid injection device being adapted to take a portion of the sample for preparation, the liquid injection device being adapted selectively and sequentially to inject a respective portion of each of the sample, the washing liquid and the elution liquid into the cartridge.

Typically, the elution sample produced by step (d) is transferred automatically to an apparatus for conducting the analytical process.

The present invention further provides a solid-phase extraction cartridge comprising first and second sorbent materials arranged to absorb thereon different respective chemical components, the cartridge comprising a chamber containing the first and second sorbent materials and having an inlet and an outlet, the first and second sorbent materials being arranged as a stack of two layers within the cartridge, the first sorbent material being disposed as an upper layer on an inlet side of the cartridge and comprising a polymeric sorbent material which is adapted to retain hydrophobic organic molecules, and the second sorbent material being disposed as a lower layer on an outlet side of the cartridge and comprising a mixed-mode silica-based sorbent material which is adapted to retain anionic and cationic components.

Preferably, equal amounts of the first and second sorbent materials are present in the cartridge.

The present invention further provides a method of automatically preparing an aqueous sample including acrylamide derived from a foodstuff, the sample being for use in an analytical process for quantitatively determining the amount of the acrylamide in the sample, the method comprising the steps of:

(a) providing a solid-phase extraction cartridge comprising first and second sorbent materials arranged to absorb thereon different respective chemical components, the cartridge comprising a chamber containing the first and second sorbent materials and having an inlet and an outlet, and disposing the cartridge in an apparatus having a liquid injection device adapted to communicate with the inlet, a source of a washing liquid and a source of an elution liquid;
(b) injecting through the inlet, using the liquid injection device at a positive fluid pressure and at a controlled flow rate, an aqueous sample including acrylamide derived from a foodstuff and impurities, thereby to disperse the sample within at least one of the first and second sorbent materials;
(c) injecting through the inlet, using the liquid injection device at a positive fluid pressure and at a controlled flow rate, a portion of the washing liquid from the source thereof so as at least partially to separate the acrylamide and the impurities within the first and second sorbent materials; and
(d) eluting acrylamide from the outlet of the cartridge by injecting through the inlet, using the liquid injection device at a positive fluid pressure and at a controlled flow rate, a portion of the elution liquid from the source thereof.

### BRIEF DESCRIPTION OF THE DRAWINGS

Embodiments of the present invention will now be described by way or example only, with reference to the accompanying drawings, in which:

FIG. 1 shows schematically a solid phase extraction (SPE) cartridge for use in a cleanup step used in a method of preparing samples for analysis according to an embodiment of the present invention;

FIGS. 2a to 2d show sequential stages of the use of the cartridge of FIG. 1 in the cleanup step; and

FIG. 3 shows schematically an apparatus for carrying out the method illustrated in FIG. 2.

### DETAILED DESCRIPTION OF THE INVENTION

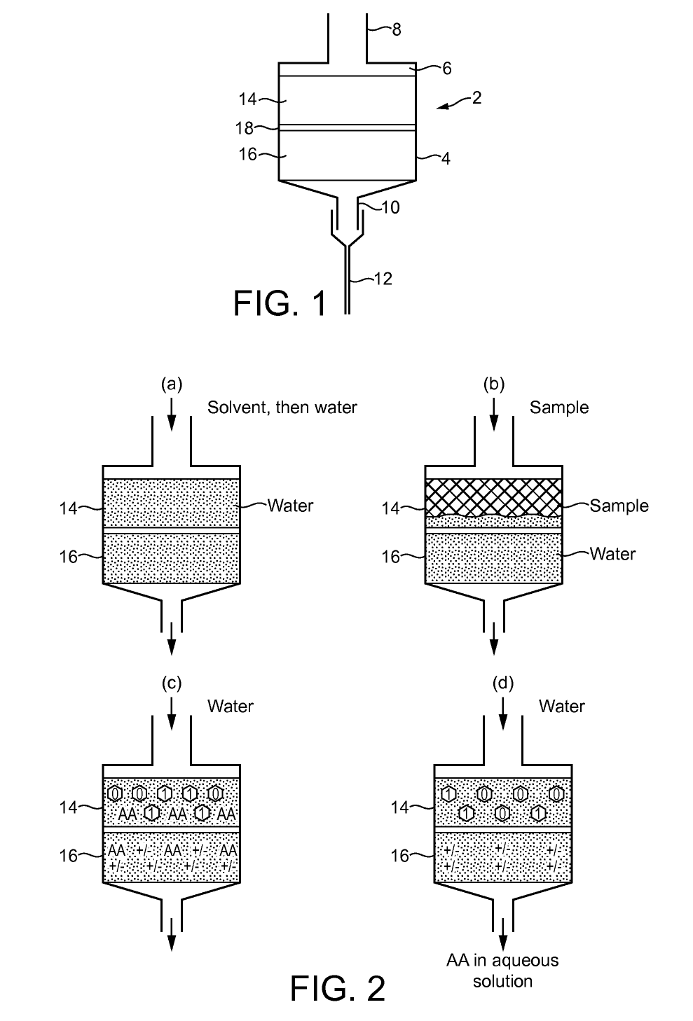

Referring to FIG. 1, a solid phase extraction (SPE) cartridge 2 comprises a housing 4 defining an internal chamber 6, the housing 4 having an inlet 8 and an outlet 10 for the chamber 6, which inlet 8 and outlet 10 are co-axially aligned. The outlet 10 is connected to a hollow needle 12 to form a syringe-like structure for the cartridge 2. The chamber 6 contains two layers of first and second sorbent material 14, 16 separated by a frit 18. Each layer of the first and second sorbent material 14, 16 respectively comprises a packed body of particulate material.

The first sorbent material 14, disposed as an upper layer on the inlet side, comprises a polymeric sorbent material which is adapted to retain hydrophobic organic molecules. In particular, the first sorbent material 14 may comprise a water-wettable reversed phase polymeric sorbent material such as Oasis HLB available in commerce from Waters Corporation, Milford, Mass., USA.

The second sorbent material 16, disposed as a lower layer on the outlet side, comprises a mixed-mode silica-based sorbent material which is adapted to retain anionic and cationic components and highly polar components. In particular, the second sorbent material 16 may comprise a water-wettable mixed-mode sorbent comprised of sulfonic acid and quaternary amine on a silica base, such as Bond Elut Accucat available in commerce from Varian, Inc., Harbor City, Calif., USA.

Although a layered cartridge 2 is disclosed in the illustrated embodiment, a mixed mode cartridge may instead be employed, incorporating a physical mixture of the two particulate sorbent materials.

Typically, the amount, for example measured by weight, of the first and second sorbent materials 14, 16 is the same, although these amounts may be varied.

A typical cartridge for use in the preferred embodiments of the present invention has a volume of 3 ml and contains 100 mg each of the first and second sorbent materials 14, 16. However, different cartridge volume and/or sorbent material amounts may be employed in accordance with the present invention.

In use, the cartridge 2 is subjected to a sequence of steps with a single-cartridge cleanup method using both sorbent materials 14, 16 in the common cartridge 2.

The cartridge 2 is subjected to the following successive steps:
1. A conditioning step, in which the sorbent materials are equilibrated with a slightly polar or polar solvent, such as methanol, and then washed with water to wet the sorbent surfaces. The solvent and then water are sequentially injected through the inlet at a preset controlled flow rate;
2. A sample addition step, in which an aqueous sample including the analyte to be analysed, the analyte being a water-soluble analyte derived from a foodstuff, such as acrylamide, is injected through the inlet at a preset controlled flow rate, this causing some separation of the components of the sample within the sorbent materials, as described in greater detail below;
3. A washing step, in which water is injected through the inlet at a preset controlled flow rate to further separate the components of the sample within the sorbent materials, as described in greater detail below; and
4. An elution step, in which water is injected through the inlet at a preset controlled flow rate to produce an elution extract flow from the outlet. This elution extract is collected for subsequent analysis.

In each step, the respective liquid is passed into the cartridge at a positive fluid pressure and at a controlled flow rate.

The elution extract is then passed to an LC/MS/MS apparatus for analysis.

Instead of water, a buffer composition may be employed both for the sample and/or for the cleanup method.

Referring to FIG. 2a, in the conditioning step the first and second sorbent materials 14, 16 are equilibrated with the solvent, such as methanol, and then washed with water to wet the sorbent surfaces. This leaves the sorbent materials 14, 16 residually wetted by water, the water injection having displaced the earlier methanol injection out through the outlet. For a cartridge having a 3 ml capacity, and containing 100 mg each of the first and second sorbent materials 14, 16, 0.5 ml of methanol and 0.5 ml of water may be injected into the cartridge, each at a controlled flow rate of 40 μl/s.

Referring to FIG. 2b, in the sample addition step, the injected sample displaces a portion of the water out through the outlet and distributes the sample through the upper sorbent material 14. For the 3 ml capacity cartridge identified above, 0.5 ml of the extract may be injected into the cartridge at a controlled flow rate of 20 μl/s.

Referring to FIG. 2c, in the washing step, using the cartridge identified above, 0.5 ml of water is injected into the cartridge at a controlled flow rate of 20 μl/s. This causes a separation of the components within the extract between the sorbent materials 14, 16. The hydrophobic organic materials, represented schematically by a benzene ring in FIG. 2, tend to be retained in the polymeric first sorbent material 14. The ionic (anionic and cationic) components, and any highly polar species, represented schematically by a +/− in FIG. 2, tend to be washed down into and retained in the mixed-mode second sorbent material 16. The water-soluble analytes, such as acrylamide, represented schematically by AA in FIG. 2, tend to be retained substantially as a band extending between the lower portion of the polymeric first sorbent material 14 and the upper portion of the mixed-mode second sorbent material 16. In other words, the dual sorbent materials effect, using the extract addition and washing steps, a chromatography-like separation of the components of the extract.

Referring to FIG. 2d, in the final elution step, water, e.g. 0.5 ml using the above-described cartridge, is injected through the inlet at a preset flow rate, e.g. 20 μl/s, to produce an aqueous elution extract flow from the outlet which is rich in the water-soluble analytes, leaving the hydrophobic organic materials and the ionic (anionic and cationic) and highly polar species retained in the cartridge.

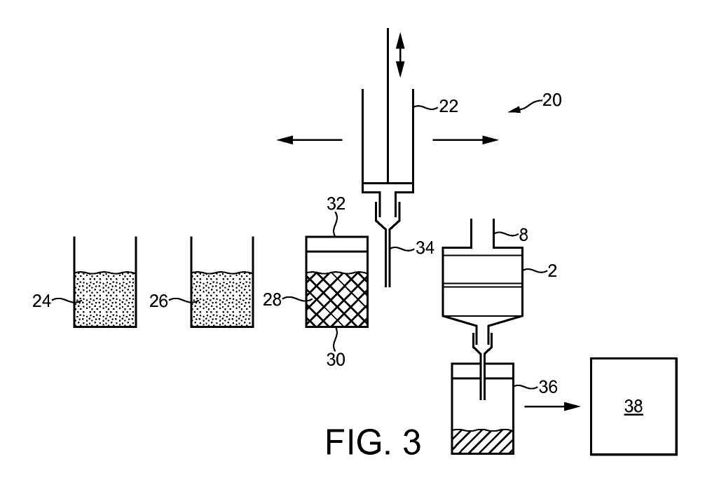

Referring to FIG. 3, in the method of the preferred embodiment of the invention the cartridge 2 is disposed in an apparatus 20 having a liquid injection device 22, in the form of a syringe, adapted to communicate with the inlet 8. The apparatus 20 is provided with a source of the conditioning solvent 24 (e.g. methanol) and a source of the washing liquid and/or the elution liquid 26 which may commonly be water, and may optionally be different. The sample 28 of aqueous liquid food extract containing the analyte to be purified, for example in a vial 30, is mounted with respect to the apparatus 20. The vial 30 may have a sealed elastomeric cap 32 through which a syringe needle 34 of the liquid injection device 22 may be pushed to take out a portion of the sample food extract. The liquid injection device 22 is selectively and sequentially controlled and operated to inject a respective portion of each of the sample 28, the conditioning solvent, the washing liquid and the elution liquid into the cartridge 2. The final elution sample is collected in another vial 36 which is then transferred automatically to an apparatus 38 for conducting the analytical process.

By using this sequence of steps in the cleanup method and employing a cartridge having two sorbent materials, this provides a number of significant advantages over prior cleanup methods for analytes of water-soluble analytes from foodstuffs, such as acrylamide, and in particular over the FDA method for acrylamide discussed above.

The use of the single cartridge including two sorbent materials permits automation of the clean up process, because there is only a single sample addition step and a single elution step, and can avoid manual handling. The cycle time can be reduced from 1.5 hours in the FDA method to less than 10 minutes.

A commercially available automatic SPE sample cleanup apparatus for preparing samples for LC/MS/MS analysis may be used, such as is available in commerce from Gerstel GmbH & Co. KG, D-45473 Mulheim an der Ruhr, Germany. The automatic SPE sample cleanup apparatus may be interfaced with the LC/MS/MS spectrometer, permitting 24 hour unattended automatic sample cleanup and analysis.

The use, in each step, of a positive fluid pressure and a controlled flow rate to inject the respective liquid into the cartridge avoids reliance on drop-wise feeding under gravity and overcomes any back-pressure problems in the FDA method caused by a blocked cartridge. Also, these steps should provide enhanced accuracy and repeatability, and reduced variation in quantitative analyte determination resulting from variations in packing density of the sorbent materials within the cartridge. The precision of the analytical results can potentially be improved.

Although the embodiment of the present invention has been particularly described with reference to the quantitative determination of acrylamide from an extract from a foodstuff, nevertheless the present invention has application to the quantitative determination of other water-soluble analytes, as part of a flavour development pathway, which may be present in foodstuffs.

Other modification to the embodiments of the present invention disclosed herein will be readily apparent to those skilled in the art.

1-22. (canceled)

23. A method of preparing an aqueous sample for use in an analytical process, the sample including at least one water-soluble analyte derived from a foodstuff, the method comprising the steps of:
(a) providing a solid-phase extraction cartridge comprising first and second sorbent materials arranged to absorb thereon different respective chemical components, the cartridge comprising a chamber containing the first and second sorbent materials and having an inlet and an outlet, wherein the first and second sorbent materials are arranged as a stack of two layers within the cartridge, the first sorbent material is disposed as an upper layer on an inlet side of the cartridge and comprises a water-wettable reversed phase polymeric sorbent material which is adapted to absorb thereon hydrophobic organic molecules and the second sorbent material is disposed as a lower layer on an outlet side of the cartridge and comprises a mixed-mode silica-based sorbent material which is adapted to absorb thereon anionic and cationic components;
(b) flowing through the inlet an aqueous sample comprising at least one water-soluble analyte derived from a foodstuff and impurities, thereby to disperse the sample within at least one of the first and second sorbent materials;
(c) flowing through the inlet a washing liquid so as at least partially to separate the at least one water-soluble analyte and the impurities within the first and second sorbent materials; and
(d) eluting the at least one water-soluble analyte from the outlet of the cartridge by flowing an elution liquid into the inlet.

24. A method according to claim 23 further comprising the step, between steps (a) and (b) of conditioning the sorbent materials by flowing at least one conditioning liquid through the inlet into the cartridge.

25. A method according to claim 23 wherein equal amounts of the first and second sorbent materials are present in the cartridge.

26. A method according to claim 23 wherein in each of steps (b), (c) and (d) the respective liquid is injected into the cartridge at a positive fluid pressure and at a controlled flow rate.

27. A method according to claim 26 wherein the controlled flow rate is preset.

28. A method according to claim 26 wherein equal controlled flow rates are employed in each of steps (b), (c) and (d).

29. A method according to claim 26 wherein equal amounts of liquid are injected through the inlet in each of steps (b), (c) and (d).

30. A method according to claim 23 wherein the at least one water-soluble analyte comprises acrylamide.

31. A method according to claim 23 further comprising the step of disposing the cartridge in an apparatus having a liquid injection device adapted to communicate with the inlet, a source of the washing liquid and a source of the elution liquid, the sample being mounted with respect to the apparatus and the liquid injection device being adapted to take a portion of the sample for preparation, the liquid injection device being adapted selectively and sequentially to inject a respective portion of each of the sample, the washing liquid and the elution liquid into the cartridge.

32. A method according to claim 23 wherein the elution sample produced by step (d) is transferred automatically to an apparatus for conducting the analytical process.

33. A solid-phase extraction cartridge comprising first and second sorbent materials arranged to absorb thereon different respective chemical components, the cartridge comprising a chamber containing the first and second sorbent materials and having an inlet and an outlet, the first and second sorbent materials being arranged as a stack of two layers within the cartridge, the first sorbent material being disposed as an upper layer on an inlet side of the cartridge and comprising a water-wettable reversed phase polymeric sorbent material which is adapted to retain hydrophobic organic molecules, and the second sorbent material being disposed as a lower layer on an outlet side of the cartridge and comprising a mixed-mode silica-based sorbent material which is adapted to retain anionic and cationic components.

34. A cartridge according to claim 33 wherein equal amounts of the first and second sorbent materials are present in the cartridge.

35. A method of automatically preparing an aqueous sample including acrylamide derived from a foodstuff, the sample being for use in an analytical process for quantitatively determining the amount of the acrylamide in the sample, the method comprising the steps of:
(a) providing a solid-phase extraction cartridge comprising first and second sorbent materials arranged to absorb thereon different respective chemical components, the cartridge comprising a chamber containing the first and second sorbent materials and having an inlet and an outlet, wherein the first and second sorbent materials are arranged as a stack of two layers within the cartridge, the first sorbent material is disposed as an upper layer on an inlet side of the cartridge and comprises a water-wettable reversed phase polymeric sorbent material which is adapted to absorb thereon hydrophobic organic molecules and the second sorbent material is disposed as a lower layer on an outlet side of the cartridge and comprises a mixed-mode silica-based sorbent material which is adapted to absorb thereon anionic and cationic components, and disposing the cartridge in an apparatus having a liquid injection device adapted to communicate with the inlet, a source of a washing liquid and a source of an elution liquid;
(b) injecting through the inlet, using the liquid injection device at a positive fluid pressure and at a controlled flow rate, an aqueous sample including acrylamide derived from a foodstuff and impurities, thereby to disperse the sample within at least one of the first and second sorbent materials;
(c) injecting through the inlet, using the liquid injection device at a positive fluid pressure and at a controlled flow rate, a portion of the washing liquid from the source thereof so as at least partially to separate the acrylamide and the impurities within the first and second sorbent materials; and
(d) eluting acrylamide from the outlet of the cartridge by injecting through the inlet, using the liquid injection device at a positive fluid pressure and at a controlled flow rate, a portion of the elution liquid from the source thereof.

36. A method according to claim 35 wherein the controlled flow rate is preset.

37. A method according to claim 35 wherein equal controlled flow rates are employed in each of steps (b), (c) and (d).

38. A method according to claim 35 wherein equal amounts of liquid are injected through the inlet in each of steps (b), (c) and (d).
